(19) United States
(12) Patent Application Publication
(10) Pub. No.: US 2023/0055139 A1
(43) Pub. Date: Feb. 23, 2023

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi Aichi-ken (JP)

(72) Inventors: Tomo Sasaki, Toyota-shi Aichi-ken (JP); Kenichi Yamada, Nisshin-shi Aichi-ken (JP); Koki Maeda, Miyoshi-shi Aichi-ken (JP); Tsuyoshi Okada, Nagoya-shi Aichi-ken (JP)

(21) Appl. No.: 17/889,769

(22) Filed: Aug. 17, 2022

(30) Foreign Application Priority Data
Aug. 19, 2021 (JP) 2021-134016

(51) Int. Cl. H04N 7/18; G06Q 10/02

(52) U.S. Cl. CPC H04N 7/183; G06Q 10/02; B60W 60/001

(57) ABSTRACT

An information processing apparatus has a controller configured to obtain a first image. The first image is an image of the interior of a specific compartment of a storage apparatus that is a candidate compartment in which baggage of a user is to be stored. The controller sends the first image to a user terminal associated with the user.

### CROSS REFERENCE TO THE RELATED APPLICATION

This application claims the benefit of Japanese Patent Application No. 2021-134016, filed on Aug. 19, 2021, which is hereby incorporated by reference herein in its entirety.

### BACKGROUND

### Technical Field

The present disclosure relates to a technology for helping users in making a reservation for a storage apparatus in which the user can put baggage.

### Description of the Related Art

Patent Literature 1 in the following citation list discloses a management system used to manage autonomously driven vehicles provided with lockers. The management system disclosed in Patent Literature 1 includes a server that manages the status of use of autonomously driven lockers (i.e. lockers provided in autonomously driven vehicles) and fixed lockers. When a request for use of a locker is made by a user, the server makes a reservation for an autonomously driven locker or a fixed locker taking the status of use of the lockers into consideration.

### CITATION LIST

### Patent Literature

Patent Literature 1: Japanese Patent Application

Laid-Open No. 2019-096201

### SUMMARY

An aspect of this disclosure is to provide a technology that can improve convenience of users when they put or store baggage in a storage apparatus.

An information processing apparatus according to a first aspect of the present disclosure may comprise a controller including at least one processor, the processor being configured to execute the processing of:

obtaining a first image, the first image being an image of the interior of a specific compartment of a storage apparatus that is a candidate compartment in which baggage of a user is to be stored; and sending the first image to a user terminal associated with the user.

An information processing method according to a second aspect of the present disclosure may comprise:

obtaining a first image, the first image being an image of the interior of a specific compartment of a storage apparatus that is a candidate compartment in which baggage of a user is to be stored; and sending the first image to a user terminal associated with the user.

A non-transitory storage medium according to a third aspect of the present disclosure may be a non-transitory storage medium in which a program that controls a user terminal used by a user is stored, the program being configured to cause the user terminal to receive a first image, the first image being an image of the interior of a specific compartment of a storage apparatus that is a candidate compartment in which baggage of a user is to be stored.

The technology disclosed herein can improve convenience of users when they put or store baggage in a storage apparatus.

### BRIEF DESCRIPTION OF THE DRAWINGS

FIG. 1 is a diagram illustrating the general configuration of a reservation system according to a first embodiment.

FIG. 2 is a block diagram schematically illustrating exemplary functional configuration of a management server and a user terminal.

FIG. 3 illustrates an exemplary table structure of locker information according to the first embodiment.

FIG. 4 is a sequence diagram illustrating a process of information processing in the reservation system according to the first embodiment.

FIG. 5 is a diagram illustrating a vehicle according to a second embodiment.

FIG. 6 illustrates an exemplary table structure of locker information according to the second embodiment.

FIG. 7 is a sequence diagram illustrating a process of information processing in the reservation system according to the second embodiment.

### DESCRIPTION OF THE EMBODIMENTS

A storage apparatus disclosed herein is an apparatus in which users can store or leave baggage. The storage apparatus has compartments each of which is used to store baggage of a user. An information processing apparatus according to the first aspect of the present disclosure is an apparatus that manages the storage apparatus. The information processing apparatus has a controller. The controller may obtain a first image. The first image is an image of the interior of a specific compartment of the storage apparatus that is a candidate compartment in which baggage of the user can be stored. In other words, the first image is an image showing the condition (or circumstances) inside the compartment before baggage of the user is stored in it.

The controller may send the first image obtained as above to a user terminal associated with the user. Thus, the user can check the condition inside the specific compartment of the storage apparatus by the first image. In consequence, the user can determine whether or not to use this specific compartment to store his/her baggage taking the condition inside the specific compartment into consideration. This can improve the convenience of the user when he or she store baggage in the storage apparatus.

In the following, specific embodiments of the technology disclosed herein will be described with reference to the drawings. It should be understood that the following description of the embodiment will be given by way of illustration, and the technology disclosed herein is not limited to the illustrative configuration of the embodiment unless stated otherwise.

### First Embodiment

### General Configuration of System

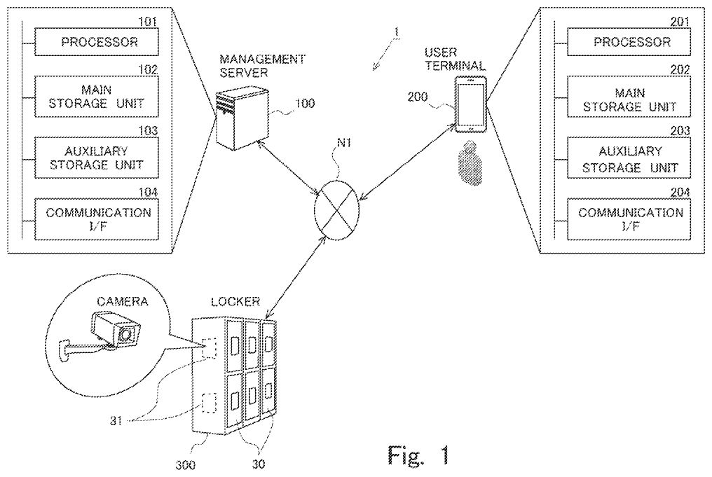

FIG. 1 is a diagram illustrating the general configuration of a reservation system of a first embodiment. The reservation system 1 is a system that manages reservations of lockers that users make to store their baggage (which will be referred to as “user's baggage” hereinafter). The reservation system 1 includes a management server 100, a user terminal 200, and lockers 300. The management server 100, the user terminal 200, and the lockers 300 in the reservation system 1 are interconnected by a network N1. The network N1 may be, for example, a WAN (Wide Area Network), which may be a global public communication network such as the Internet, or a telephone communication network, such as cellular phone communication network.

The management server 100 is a server apparatus that manages a plurality of lockers 300. The management server 100 manages a plurality of lockers 300 installed at different places. For the sake of simplicity of illustration, only one of the lockers 300 is illustrated in FIG. 1.

The management server 100 includes a computer having a processor 101, a main storage unit 102, an auxiliary storage unit 103, and a communication interface 104. The processor 101 is, for example, a CPU (Central Processing Unit) or a DSP (Digital Signal Processor). The main storage unit 102 is, for example, a RAM (Random Access Memory). The auxiliary storage unit 103 is, for example, a ROM (Read Only Memory), an HDD (Hard Disk Drive), or a flash memory. The auxiliary storage unit 103 may include a removable medium or a portable recording medium. Examples of the removable medium include a USB memory, an SD card, and disc recording media, such as a CD-ROM, a DVD, and a Blu-ray disc. The communication interface 104 is, for example, a LAN (Local Area Network) interface board or a wireless communication circuit for wireless communication.

The auxiliary storage unit 103 stores an operating system (OS), various programs, and various information tables. The processor 101 loads a program stored in the auxiliary storage unit 103 into the main storage unit 102 and executes it to implement controls for managing reservations for use of the lockers 300 by the users, which will be described later. The functions of the management server 100 may be implemented partly or entirely by a hardware circuit(s), such as an ASIC or an FPGA. The management server 100 is not necessarily constructed as a single physical entity, but it may be constructed by a plurality of cooperating computers. The management server 100 of this embodiment corresponds to the information processing apparatus according the present disclosure.

The locker 300 has a plurality of compartments 30 in which user's baggage can be stored. Each compartment 30 of the locker 300 is lockable and unlockable. Each compartment 30 of the locker 300 is provided with a camera 31 capable of capturing an image of the interior of the compartment 30. The image captured by each camera 31 may be either a still image or a moving image. The locker 300 has a communication interface capable of sending image data captured by the cameras 31 to the management server 100 through the network N1. The locker 300 of this embodiment corresponds to the storage apparatus according to the present disclosure.

The user terminal 200 is a terminal used by a user who intends to use the locker 300. The user terminal 200 includes a computer having a processor 201, a main storage unit 202, an auxiliary storage unit 203, and a communication interface 204. Examples of the processor 201, the main storage unit 202, and the auxiliary storage unit 203 are the same as the aforementioned examples of the processor 101, the main storage unit 102, and the auxiliary storage unit 103 of the computer that constitutes the management server 100. An example of the communication interface 204 is an interface capable of communicating with other devices including the management server 100 via the network N1, using a mobile communication service, such as 3G (3rd Generation) mobile communication service or LTE (Long Term Evolution) mobile communication service.

A certain application is executed in the user terminal 200 to perform control for making a reservation for use of the locker 300 as will be described later. Examples of the user terminal 200 include a smartphone, a tablet computer, a mobile computer, and a wearable computer.

The user conducts an operation for making a reservation for use of the locker 300 on the user terminal 200. This operation will also be referred to as “reservation operation” hereinafter. When the reservation operation is conducted on the user terminal 200, the user terminal 200 sends a request for reservation to the management server 100. Then, the management server 100 executes processing for making a reservation for the locker 300 on the basis of the request for reservation received from the user terminal 200. This processing will also be referred to as “reservation processing” hereinafter.

Before performing the reservation operation, the user designates, on the user terminal 200, one of the compartments 30 of the locker 300 as a candidate compartment in which user's baggage is to be stored. In the following, the compartment 30 designated by the user as the candidate compartment in which user's baggage is to be stored will be referred to as “specific compartment 30a”. After the specific compartment 30a is selected on the user terminal 200, the user terminal 200 sends a request for sending a first image to the management server 100. The first image is an image of the interior of the specific compartment 30a.

When the management server 100 receives the request for sending a first image from the user terminal 200, the management server 100 obtains the first image captured by the camera 31 provided in the specific compartment 30a from the locker 300. Then, the management server 100 sends the first image of the specific compartment 30a obtained from the locker 300 to the user terminal 200. In consequence, the user can see the first image to check the condition inside the specific compartment 30a, which the user has designated as a candidate compartment in which user's baggage is to be stored, before making a reservation for use of the locker 300.

### Functional Configuration

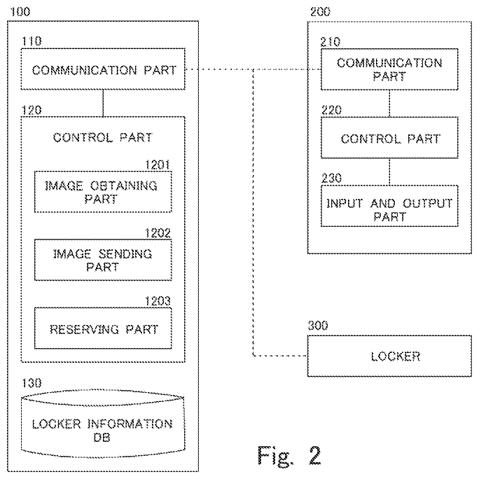

The functional configurations of the management server 100 and the user terminal 200 in the reservation system 1 will be described next with reference to FIG. 2. FIG. 2 is a block diagram schematically illustrating exemplary functional configurations of the management server 100 and the user terminal 200.

### Management Server

The management server 100 has a communication part 110, a control part 120, and a locker information database 130. The communication part 110 has the function of connecting the management server 100 to the network N1. The communication part 110 may be implemented by the communication interface 104. The control part 120 has the function of executing computation for controlling the management server 100. The control part 120 may be implemented by the processor 101. The control part 120 executes the processing of receiving the request for sending a first image of the specific compartment 30a from the user terminal 200 through the communication part 110.

The control part 120 includes, as functional components, an image obtaining part 1201, an image sending part 1202, and a reserving part 1203. The image obtaining part 1201 has the function of obtaining the first image of the specific compartment 30a from the locker 300. Specifically, the image obtaining part 1201 executes the processing of sending a command to capture the first image of the specific compartment 30a to the locker 300 through the communication part 110. Moreover, the image obtaining part 1201 executes the processing of receiving the first image of the specific compartment 30a from the locker 300 through the communication part 110.

The image sending part 1202 executes the processing of sending the first image of the specific compartment 30a received from the locker 300 to the user terminal 200 through the communication part 110. The reserving part 1203 executes the reservation processing of making a reservation for the specific compartment 30a as the compartment to be used by the user, when it receives a request for reservation for the specific compartment 30a from the user terminal 200.

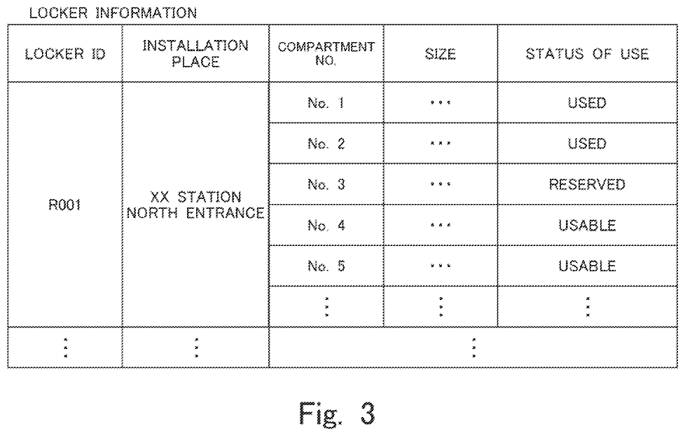

The locker information database 130 is a database in which locker information is stored. The locker information is information about the lockers 300 that are under the management of the management server 100. The locker information database 130 is constructed in the auxiliary storage unit 103. FIG. 3 illustrates an exemplary table structure of the locker information stored in the locker information database 130 in the system of this embodiment.

As illustrated in FIG. 3, the locker information includes the fields of locker ID, installation place, compartment NO., size, and status of use. What is stored in the locker ID field is a locker ID as identification information for identifying each locker 300. What is stored in the installation place field is information indicating the place where each locker 300 is installed. The information indicating the place where the locker 300 is installed may be the name of the facility in which the locker 300 is installed and information indicating the location of installation of the locker 300 in that facility. The exemplary locker information in FIG. 3 shows that the locker 300 having the locker ID “R001” is installed in the North Entrance of XX station (railway station).

What is stored in the compartment NO. field is numbers assigned to the compartments 30 that each locker 300 has. What is stored in the size field is information indicating the size of each compartment 30 of each locker 300. What is stored in the status of use field is information indicating the status of use of each compartment 30 of each locker 300. Specifically, the information “used”, “reserved”, or “usable” is stored in the status of use field as the status of use of each compartment 30. The information “used” indicates that user's baggage is presently stored in the compartment 30. The information “reserved” indicates that the compartment 30 has already been reserved. The information “usable” indicates that the compartment 30 is presently empty, and the user can make reservation for use of the compartment 30. The exemplary locker information in FIG. 3 shows that the compartments of Nos. 1 and 2 are “used”, the compartment of No. 3 is “reserved”, and the compartments of Nos. 4 and 5 are “usable”. The information stored in the status of use field of the locker information is updated by the control part 120 in accordance with the status of use or reservation of each compartment 30 of each locker 300.

### User's Terminal

The user terminal 200 has a communication part 210, a control part 220, and an input and output part 230. The communication part 210 has the function of connecting the user terminal to the network N1. The communication part 210 may be implemented by the communication interface 204. The control part 220 has the function of executing computation for controlling the user terminal 200. The control part 220 may be implemented by the processor 201.

The input and output part 230 has the function of receiving input operations by the user and the function of presenting information to the user. For example, the input and output part 230 may include a touch display panel. In that case, the control part 220 may run a certain application to allow the user to conduct input operations on the touch panel display of the input and output part 230.

Procedure of Information Processing

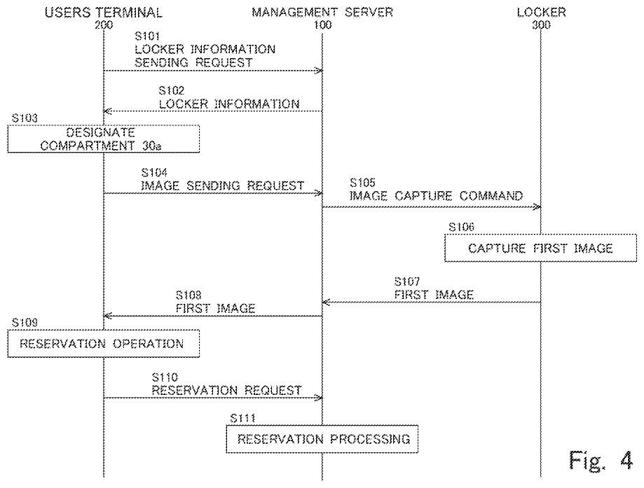

A procedure of information processing performed in the reservation system 1 of this embodiment will now be described with reference to FIG. 4. FIG. 4 is a sequence diagram illustrating a procedure of information processing performed in the reservation system 1 of this embodiment. FIG. 4 illustrates a procedure of information processing that is performed when the user makes a reservation for use of the locker 300 in the reservation system 1.

When the user makes a reservation for use of the locker 300 with the reservation system 1 of this embodiment, the user himself/herself selects a locker 300 and a compartment 30 for storing user's baggage. For this purpose, the user conducts an operation on the user terminal 200 to search for a locker 300 that he or she can use. When the user terminal 200 receives this user's operation through the input and output part 230, the user terminal 200 sends a request for sending locker information to the management server 100 (S101).

When the management server 100 receives the request for sending locker information from the user terminal 200, the management server 100 sends locker information stored in the locker information database 130 to the user terminal 200 (S102). The request for sending locker information sent from the user terminal 200 may contain information about a place (e.g. facility or area etc.) where the user wants to use a locker 300. Then, the management server 100 retrieves locker information about lockers 300 that are installed in the place where the user wants to use a locker 300 or at locations within a certain range from that place from the locker information database 130 and sends the retrieved information to the user terminal 200.

When the user terminal 200 receives the locker information from the management server 100, the user terminal 200 presents the locker information to the user through the input and output part 230. Then, the user designates a specific compartment 30a as a candidate compartment in which user's baggage is to be stored on the basis of the presented locker information. Specifically, the user designates the specific compartment 30a from among the compartments 30 that are indicated “usable” in the locker information. In this process, the user terminal 200 receives the operation of designating the specific compartment 30a conducted by the user through the input and output part 230 (S103).

Then, the user terminal 200 sends a request for sending a first image of the specific compartment 30a to the management server 100 (S104). The management server 100 receives the request for sending a first image from the user terminal 200 and subsequently sends a command to capture a first image of the specific compartment 30a to the locker 300 that includes the specific compartment 30a (S105).

When the locker 300 receives this image capture command from the management server 100, the locker 300 captures a first image using the camera 31 provided in the specific compartment 30a (S106). Then, the locker 300 sends the first image of the specific compartment 30a to the management server 100 (S107). The processing of sending the image capture command to the locker 300 and the processing of receiving the first image from the locker 300 are executed by the image obtaining part 1201 of the management server 100.

After receiving the first image of the specific compartment 30a from the locker 300, the management server 100 sends the first image to the user terminal 200 (S108). The processing of sending the first image to the user terminal 200 is executed by the image sending part 1202 of the management server 100.

The user terminal 200 receives the first image of the specific compartment 30a from the management server 100 and subsequently presents the first image to the user through the input and output part 230. Thus, the user can check the condition inside the specific compartment 30a by the first image. Then, the user can determine whether or not to store user's baggage in the specific compartment 30a taking the condition inside the specific compartment 30a into consideration.

If the user determines to store user's baggage in the specific compartment 30a, the user makes a reservation for use of the specific compartment 30a. For this purpose, the user terminal 200 receives a reservation operation for making a reservation for the specific compartment 30a conducted by the user through the input and output part 230 (S109). The user may designate a further compartment 30 other than the compartment of which the user has checked the interior by the first image as a specific compartment 30a again. In that case, the processing of S103 through S108 is executed again. Thus, the user can determine a compartment in which user's baggage is to be stored based on first images of a plurality of compartments 30.

When the user terminal 200 receives the operation for making a reservation for the specific compartment 30a by the user, it sends a request for reservation of the specific compartment 30a to the management server 100 (S110). The management server 100 receives the request for reservation from the user terminal 200 and subsequently executes reservation processing to make a reservation for the specific compartment 30a as the compartment to be used by the user (S111). The reservation processing of making a reservation for the specific compartment 30a is executed by the reserving part 1203 of the management server 100. When the reservation processing is executed by the management server 100, the status of use of the specific compartment 30a in the locker information database 130 is changed from “usable” to “reserved”.

As above, the reservation system 1 allows the user who wants to use a locker 300 to make a reservation for the specific compartment 30a in which user's baggage is to be stored after checking the condition inside the specific compartment 30a. This can improve the convenience of the user in storing user's baggage in the locker 300.

### First Modification

Next, a modification of the reservation system 1 of the first embodiment will be described. In the above-described reservation system 1 of the first embodiment, the specific compartment 30a is determined by the user on the user terminal 200 on the basis of the locker information received from the management server 100. In the system of this modification, the specific compartment 30a is selected by the management server 100 as a compartment recommended to the user for use.

In the system of this modification, the request for sending locker information sent from the user terminal 200 to the management server 100 contains information about a place where the user wants to use a locker 300. Moreover, the request for sending locker information also contains information about the size of user's baggage to be stored.

The management server 100 firstly retrieves locker information about lockers 300 that are installed in the place where the user wants to use a locker 300 or at locations within a certain range from that place from the locker information database 130. Then, the management server 100 selects a compartment 30 in which the user can store user's baggage on the basis of the locker information of the lockers 300 retrieved as above. Specifically, the management server 100 selects a compartment 30 of which the locker information indicates that its size is larger than the size of the user's baggage and the status of use is “usable” as a specific compartment 30a.

Subsequently, the management server 100 sends the locker information about the specific compartment 30a to the user terminal 200. The user terminal 200 receives the locker information from the management server 100 and presents the locker information about the specific compartment 30a to the user through the output part 230. Then, if the user conducts the operation of making a request for sending a first image of the specific compartment 30a, the user terminal 200 sends a request for sending a first image to the management server 100. Thereafter, the processing same as the processing of S105 onward in the sequence diagram of FIG. 4 is performed.

The locker information stored in the locker information database 130 may include information about functions that each compartment 30 of each locker 300 has. An example of the functions that the compartment 30 has is a refrigeration function for cold storage or refrigerated storage. The request for sending locker information sent from the user terminal 200 to the management server 100 may contain information about properties of user's baggage. An example of such properties of user's baggage is food that needs cold or refrigerated storage.

The management server 100 may select the specific compartment 30a on the basis of the respective functions that the compartments 30 of the lockers 300 have and the properties of the user's baggage. For example, if the user's baggage is a food that needs cold storage, the management server 100 may select a compartment 30 having a cold storage function as the specific compartment 30a. If the user's baggage is a food that needs refrigerated storage, the management server 100 may select a compartment 30 having a refrigerated storage function as the specific compartment 30a. In this way, even in the case where the specific compartment 30a is selected by the management server 100, an appropriate compartment that matches the properties of the user's baggage can be selected.

### Second Embodiment

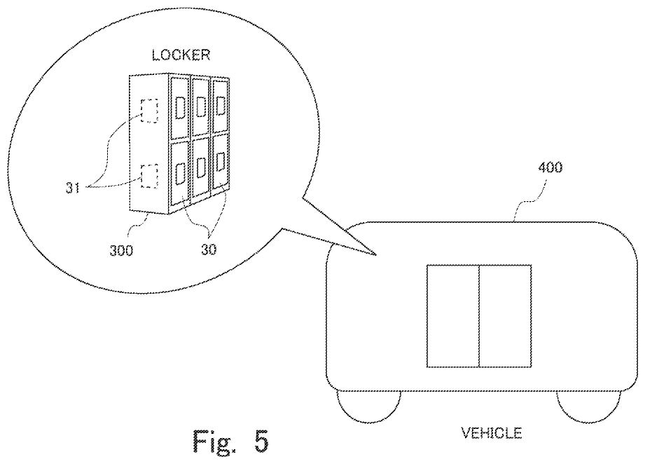

A reservation system 1 according to a second embodiment will be described next. The reservation system 1 of the second embodiment includes a management server 100, a user terminal 200, and lockers 300, as with the reservation system 1 of the first embodiment. The reservation system 1 of this embodiment differs from the above-described system of the first embodiment in that a locker 300 is provided on a vehicle 400 as illustrated in FIG. 5. FIG. 5 is a diagram illustrating the vehicle 400 used in the system of this embodiment. The vehicle 400 on which the locker 300 is provided is an autonomous vehicle capable of travelling autonomously.

The vehicle 400 is not necessarily a vehicle with no human aboard. For example, a maintenance person may be aboard on the vehicle 400. The vehicle 400 is not necessarily a fully autonomous vehicle. For example, the vehicle 400 may be a vehicle that can be driven or assisted by human as circumstances demand. In the following, features of the reservation system 1 according to the second embodiment that are different from or absent in the first embodiment will be mainly described.

The vehicle 400 autonomously travels around along a predetermined travel route. However, when a user uses the locker 300 provided on the vehicle 400, the vehicle 400 travels autonomously to a location at which the user wants to put or take out user's baggage into or from the locker 300. This location will also be referred to as “location of use” hereinafter.

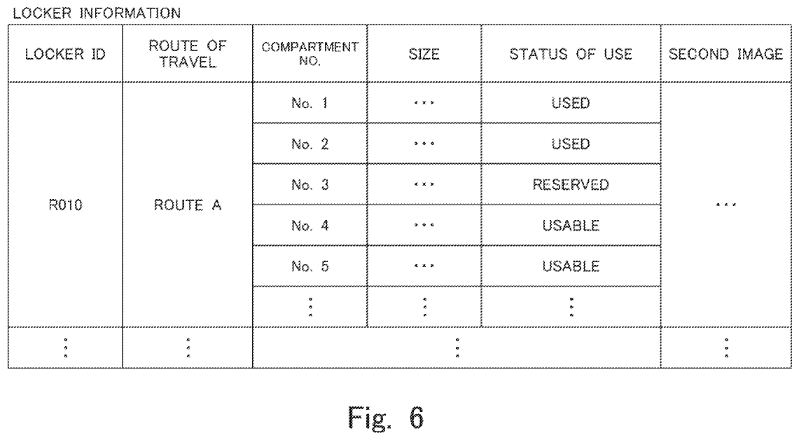

The management server 100 in the system of this embodiment also has a locker information database 130 in which locker information about a plurality of lockers 300 is stored. FIG. 6 illustrates an exemplary table structure of the locker information stored in the locker information database 130 according to this embodiment. As illustrated in FIG. 6, the locker information according to this embodiment has a travel route field in place of the installation place field in the locker information illustrated in FIG. 3. What is stored in the travel route field is information indicating the respective travel routes of the vehicles 400 provided with the lockers 300. The exemplary locker information in FIG. 6 shows that the travel route of the vehicle 400 provided with the locker 300 having the locker ID “R010” is route A.

The locker information according to this embodiment further has a second image field, as illustrated in FIG. 6. What is stored in the second image field is image data of a second image relating to each locker 300. The second image is an image showing the behavior of an article stored in any one of the compartments 30 of the locker 300 during the travel of the vehicle 400. The second image is a moving image captured in advance by the camera 31 provided in a compartment 30 in which an article is stored while the vehicle 400 is travelling with the article being stored in the compartment 30 of the locker 300. The information indicating the size and the status of use of each compartment 30 included in the locker information according to this embodiment is the same as that included in the locker information according to the first embodiment.

### Procedure of Information Processing

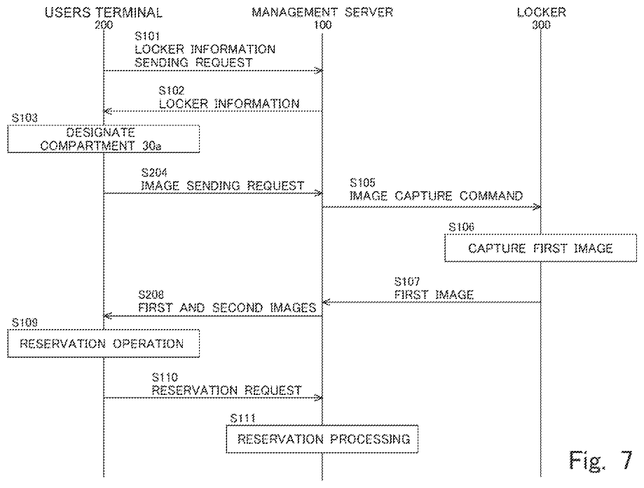

A procedure of information processing performed in the reservation system 1 of this embodiment will now be described with reference to FIG. 7. FIG. 7 is a sequence diagram illustrating a procedure of information processing performed in the reservation system 1 of this embodiment. In the following, the processing that is different from or absent in the processing performed by the reservation system 1 of the first embodiment illustrated in FIG. 4 will be described.

In the reservation system 1 of this embodiment also, when the user terminal 200 receives an operation conducted by the user through the input and output part 230, it sends a request for sending locker information to the management server 100 (S101). The request for sending locker information sent from the user terminal 200 contains information about the location of use. If the location of use is located within a predetermined range from the route of travel of a vehicle 400, it can travel autonomously to the location of use. Then, the management server 100 retrieves locker information about the locker 300 provided on the vehicle 400 that has a travel route that meets the condition that the location of use is located within the predetermined range from it from the locker information database 130 and sends the retrieved locker information to the use's terminal 200. Thus, the locker information about the locker 300 that the user can use at the location of use is sent to the user terminal 200.

When the user designates a specific compartment 30a, the user terminal 200 sends a request for sending a first image of the specific compartment 30a and a second image relating to the locker 300 including the specific compartment 30a to the management server 100 (S204). The management server 100 sends a command to capture the first image to the locker 300 including the specific compartment 30a and receives the first image from the locker 300. Then, the management server 100 sends the first image received from the locker 300 and the second image relating to the locker 300 including the specific compartment 30a to the user terminal 200 (S208). In this process, the management server 100 obtains the second image from the locker information database 130. The processing of obtaining the second image from the locker information database 130 is executed by the image sending part 1202 of the management server 100. The processing of sending the second image to the use's terminal 200 with the first image is executed by the image sending part 1202 of the management server 100.

When the user terminal 200 receives the first image of the specific compartment 30a and the second image relating to the locker 300 including the specific compartment 30a from the management server 100, the user terminal 200 presents the first and second images to the user through the input and output part 230. Thus, the user can check the condition inside the specific compartment 30a by the first image. Moreover, the user can check the behavior of an article stored in a compartment 30 of the locker 300 during the travel of the vehicle 400 on which the locker 300 including the specific compartment 30a is provided by the second image. This enables the user to see how user's baggage will behave during the travel of the vehicle 400 on which the locker 300 including the specific compartment 30a is provided, if the user stores the user's baggage in the specific compartment 30a.

As above, according to this embodiment, the user who wants to use the locker 300 provided on the vehicle 400 can check the condition inside the specific compartment 30a in which user's baggage is to be stored. Moreover, the user can check how the user's baggage in the specific compartment 30a will behave during the travel of vehicle 400. The user can make a reservation for the specific compartment 30a after checking it in these respects.

How the user's baggage stored in a compartment 30 of the locker 300 will behave during the travel of the vehicle 400 may vary depending on the performance of the vehicle 400 or the travel route of the vehicle 400. The reservation system 1 of this embodiment stores the second image relating to each locker 300 in the locker information database 130. The second image relating to the locker 300 including the specific compartment 30a designated by the user is presented to the user. Thus, the user can see how the user's baggage will behave in the specific compartment 30a during the travel of the vehicle 400 more appropriately.

It is not necessarily required that the second image relating to each locker 300 be stored in the locker information database 130. For example, the second image may be stored in a storage unit that each locker 300 has. In that case, the management server 100 obtains the second image from the locker 300 including the specific compartment 30a together with the first image.

In this embodiment also, it is not necessarily required that the second image be sent from the management server 100 to the user terminal 200. For example, the user terminal 200 may send a request for sending the second image to the management server 100 only in the case where the user wants the second image to be presented by the user terminal 200 in addition to the first image.

### Other Embodiments

The embodiments described above are merely examples, and the present disclosure may be changed and implemented as appropriate within the scope of the disclosure. Furthermore, processes and means described in the present disclosure may be freely combined to the extent that no technical conflict exists.

Furthermore, a process that is described to be performed by one apparatus may be shared and performed by a plurality of apparatuses. Processes described to be performed by different apparatuses may be performed by one apparatus. Which function is to be implemented by which hardware configuration (server configuration) in a computer system may be flexibly changed.

The present disclosure may also be implemented by supplying computer programs for implementing the functions described in the embodiments described above to a computer, and by one or more processors of the computer reading out and executing the programs. Such computer programs may be provided to the computer by a non-transitory computer-readable storage medium that can be connected to a system bus of the computer, or may be provided to the computer through a network. The non-transitory computer-readable storage medium may be any type of disk including magnetic disks (floppy (registered trademark) disks, hard disk drives (HDDs), etc.) and optical disks (CD-ROMs, DVD discs, Blu-ray discs, etc.), and any type of medium suitable for storing electronic instructions, such as read-only memories (ROMs), random access memories (RAMs), EPROMs, EEPROMs, magnetic cards, flash memories, or optical cards.

What is claimed is:

1. An information processing apparatus comprising a controller including at least one processor, the controller being configured to execute the processing of:
obtaining a first image, the first image being an image of the interior of a specific compartment of a storage apparatus that is a candidate compartment in which baggage of a user is to be stored; and
sending the first image to a user terminal associated with the user.

2. The information processing apparatus according to claim 1, wherein when the controller receives a request for sending the first image from the user terminal, the controller obtains the first image captured by a camera provided in the specific compartment.

3. The information processing apparatus according to claim 1, wherein the storage apparatus is provided on a vehicle capable of travelling autonomously, and the controller further executes the processing of sending a second image to the user terminal, the second image being an image showing a behavior of an article stored in any one of the compartments of the storage apparatus during the travel of the vehicle.

4. The information processing apparatus according to claim 3, wherein the second image is a moving image that is captured in advance while the vehicle is traveling with the article being stored in any one of the compartments of the storage apparatus.

5. The information processing apparatus according to claim 4, wherein when the controller receives a request for sending the second image from the user terminal, the controller retrieves the second image stored in the storage unit.

6. The information processing apparatus according to claim 3, wherein the vehicle is a vehicle that travels along a specific route.

7. The information processing apparatus according to claim 1, wherein the controller further executes the processing of sending locker information including information about the status of use of each of the compartments of one or a plurality of storage apparatuses to the user terminal.

8. The information processing apparatus according to claim 7, wherein the specific compartment is a compartment selected by the user on the basis of the locker information.

9. The information processing apparatus according to claim 1, wherein the controller further executes the processing of selecting the specific compartment as a compartment recommended to the user for use on the basis of locker information including information about the status of use of each of the compartments of one or a plurality of storage apparatuses.

10. The information processing apparatus according to claim 9, wherein the locker information includes information about a function that each of the compartments of the one or plurality of storage apparatuses has, and the controller further executes the processing of receiving information about properties of the user's baggage from the user terminal and selecting the specific compartment on the basis of the locker information and the properties of the user's baggage.

11. An information processing method comprising:
obtaining a first image, the first image being an image of the interior of a specific compartment of a storage apparatus that is a candidate compartment in which baggage of a user is to be stored; and
sending the first image to a user terminal associated with the user.

12. The information processing method according to claim 11, further comprising receiving a request for sending the first image from the user terminal, wherein the first image is captured by a camera provided in the specific compartment when the request for sending the first image is received from the user terminal.

13. The information processing method according to claim 11, wherein the storage apparatus is provided on a vehicle capable of travelling autonomously, and the method further comprises sending a second image to the user terminal, the second image being an image showing a behavior of an article stored in any one of the compartments of the storage apparatus during the travel of the vehicle.

14. The information processing method according to claim 13, wherein the second image is a moving image that is captured in advance while the vehicle is traveling with the article being stored in any one of the compartments of the storage apparatus.

15. The information processing method according to claim 14, further comprising receiving a request for sending the second image from the user terminal, wherein the second image stored in a storage unit is retrieved when the request for sending the second image is received from the user terminal.

16. The information processing method according to claim 13, wherein the vehicle is a vehicle that travels along a specific route.

17. A non-transitory storage medium in which a program that controls a user terminal used by a user is stored, the program being configured to cause the user terminal to receive a first image, the first image being an image of the interior of a specific compartment of a storage apparatus that is a candidate compartment in which baggage of a user is to be stored.

18. The non-transitory storage medium according to claim 17, wherein the program causes the user terminal to send a request for sending the first image, and the first image is an image captured by a camera provided in the specific compartment in response to sending of the request by the user terminal.

19. The non-transitory storage medium according to claim 17, wherein the storage apparatus is provided on a vehicle capable of travelling autonomously, and the program causes the user terminal to receive a second image, the second image being an image showing a behavior of an article stored in any one of the compartments of the storage apparatus during the travel of the vehicle.

20. The non-transitory storage medium according to claim 19, wherein the second image is a moving image that is captured in advance while the vehicle is traveling with the article being stored in any one of the compartments of the storage apparatus.
